(19) United States
(12) Patent Application Publication
(10) Pub. No.: US 2020/0126002 A1
(43) Pub. Date: Apr. 23, 2020

(54) ELECTRONIC TICKET ISSUE, REISSUE, TRACKING, AUTHENTICATION, APPARATUS, METHOD, AND A PROCESS THEREOF

(71) Applicant: Andrew Plevin, New York, NY (US)

(72) Inventor: Andrew Plevin, New York, NY (US)

(21) Appl. No.: 16/660,555

(22) Filed: Oct. 22, 2019

Related U.S. Application Data
(60) Provisional application No. 62/749,658, filed on Oct. 23, 2018.

(51) Int. Cl. G06Q 10/02

(52) U.S. Cl. CPC G06Q 10/02; G06Q 30/0641

(57) ABSTRACT

The present invention relates generally to an electronic ticket issue, reissue, tracking, authentication, apparatus, method, and a process thereof. More particularly, the invention encompasses an electronic network system where a ticket or an event invitation would be electronically issued, which ticket or event invitation could also be reissued or transferred per an existing or a case-by-case rule, and the ticket or an event invitation would be tracked, and authenticated at each step to ensure validity of the ticket or the event invitation. The invention farther includes a process of converting a passive electronic ticket into an electronic multimedia ticket. The electronic ticket could also have features Where additional information could be associated with an issued ticket or a reissued ticket for the benefit of the user or buyer.

### CROSS-REFERENCE TO RELATED APPLICATION

The instant patent application claims priority to and the benefit of pending U.S. Provisional Patent Application Ser. No. 62/749,658, filed on Oct. 23, 2018, titled “ELECTRONIC TICKET ISSUE, REISSUE, TRACKING, AUTHENTICATION, APPARATUS, METHOD, AND A PROCESS THEREOF,” the entire disclosure of which provisional application is incorporated herein by reference.

### FIELD OF THE INVENTION

The present invention relates generally to an electronic ticket issue, reissue, tracking authentication, apparatus, method, and a process thereof. More particularly, the invention encompasses an electronic network system where a ticket or an event invitation would be electronically issued, which ticket or event invitation could also be reissued or transferred per an existing or a case-by-case rule, and the ticket or an event invitation would be tracked, and authenticated at each step to ensure validity of the ticket or the event invitation. The invention further includes a process of converting a passive electronic ticket into an electronic multimedia ticket. The electronic ticket could also have features where additional information could be associated with an issued ticket or a reissued ticket for the benefit of the user or buyer.

### PURPOSES AND SUMMARY OF THE INVENTION

The invention is a novel electronic ticket issue, reissue, tracking, authentication, apparatus, method, and a process thereof.

Therefore, one purpose of this invention is to provide a electronic ticket issue, reissue, tracking, authentication, apparatus, method, and a process thereof

Another purpose of this invention is to provide a process of converting a passive electronic ticket into an electronic multimedia ticket.

Yet another purpose of this invention is to provide the electronic ticket with features where additional information can be associated with an issued or reissued ticket for the benefit of the user or buyer.

Therefore, in one aspect this invention comprises a method of providing electronic tickets to a buyer, comprising the steps of:

(a) At least one vendor selling at least two tickets in at least one primary market;
(b) At least one first buyer buying at least one first ticket from said at least one vendor, and wherein said at least one first buyer places said at least one first ticket on at least one resale website;
(c) Said at least one vendor placing unsold tickets on at least one second website;
(d) At least one platform integrating said at least one first ticket from said at least one resale website, and said unsold tickets from said at least one second website on said at least one platform; and
(e) At least one second buyer buying said at least one first ticket on said at least one platform, and at least one unsold ticket on said at least one platform.

In another aspect this invention comprises a method of providing electronic tickets to a buyer, comprising the steps of:

(a) At least one seller selling at least one ticket in at least one primary market;
(b) At least one entity converting said at least one ticket into a multimedia ticket by providing at least one enhancement to said ticket; and
(c) Wherein said at least one enhancement is visible on at east one platform which can be viewed by at least one buyer.

In yet another aspect this invention comprises a method of providing electronic tickets to a buyer, comprising the steps of:

(a) At least one seller selling at least one ticket in at least one primary market;
(b) At least one entity converting said at least one ticket into an informational multimedia. ticket by providing at least one informational enhancement to said ticket; and
(c) Wherein said at least one informational enhancement is visible on at least one platform which can be viewed by at least one buyer.

### BRIEF DESCRIPTION OF THE DRAWINGS

FIG. 1, illustrates a flow diagram for a first embodiment of the invention.

FIG. 2, illustrates a flow diagram for a second embodiment of the invention.

FIG. 3, illustrates a flow diagram for a third embodiment of the invention.

### DETAILED DESCRIPTION

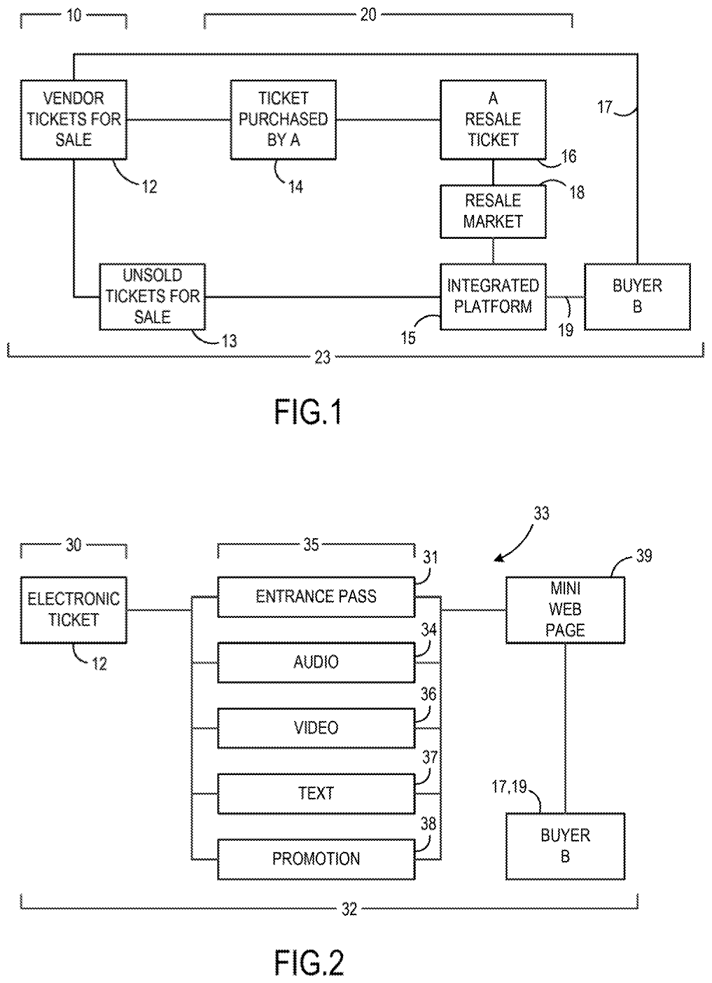

The inventive electronic ticket issue, reissue, tracking, authentication, apparatus, method and a process thereof will now be discussed with reference to FIGS. 1 through 3. Although the scope of the present invention is much broader than any particular embodiment, a detailed description of the preferred embodiment follows together with drawings. These drawings are for illustration purposes only and are not drawn to scale. Like numbers represent like features and components in the drawings.

### LIVE/LIVING TICKET-Functionality

A software and an electronic process is to be used for the issuance of an electronic ticket or an electronic event invitation for any public or private event.

This invention can be mated or partnered with any entity that issues tickets or invitations to events on a public ledger, or public block chain.

The invention publicly confirms issuance of a ticket by an entity, such as, for example, an event producer.

The invention further enables a buyer of an electronic ticket to confirm issuance and authenticity of the ticket, such as, from an event producer or an event sponsor.

This invention further enables event producer or event sponsor to confirm upon scanning electronic ticket that the ticket holder has an authentic and valid ticket or invitation, and holds a valid ticket or invitation issued for an event date, time, general seating, specified seating, or any other indicator which may be limited to, for example, a specific ticket or invitation for a unique event, date, seat, time, etc.

One aspect of this invention enables a buyer of a ticket, or a new acquirer of a ticket, to maintain anonymity upon purchase through the use of a public or private key.

With the tracking capabilities of this invention it enables the transfer, sale, resale, gift, of an electronic ticket or an invitation to a person's or entity's public key or using well known means for identification, and authentication.

This invention enables event promoter or sponsor to identify uniquely the identity of each ticket or invitation holder, and whether the ticket was purchased at the initial point of sale, or subsequently acquired via any known legal means.

This invention enables an event promoter or sponsor to track and identify the sale price of any ticket that is sold and resold, issued, reissued, etc.

Another aspect of this invention enables a ticket or invitation holder to automatically receive a bid for their ticket or invitation from another interested party interested in purchasing the owner's ticket or invitation.

This invention enables a ticket buyer to purchase tickets from the ticket sponsor or from the secondary ticket market in an integrated manner, such that bidders can purchase tickets in a designated order of purchase.

This invention also enables a ticket seller to receive payment for the sale of a ticket via any publically accepted means, such as, any electronic payment method, including a token or cryptocurrency.

This invention enables a ticket buyer to purchase a ticket via any publically accepted means, such as, any electronic payment method, including a token or cryptocurrency.

This invention enables a ticket event sponsor or promoter to receive a commission on subsequent resales of the original ticket, as the ticket is being tracked from the point of origin to the ultimate usage point of the ticket.

This invention enables a ticket event sponsor, for example, to establish and manage limitations and rules on ticket resale rights, commissions on resales, minimum price changes on resales, minimum or maximum prices for resale, and any other rules that the ticket sponsor may wish to enforce.

This invention enables event producers and sponsors, for example, to establish and pay commissions or incentives to ticket wholesalers, aggregators, and distributors (“intermediaries”), with credits or payments directly and automatically made to such sales channels and agents based upon agreed upon arrangements established between an event sponsor and intermediaries.

This invention enables an event producer to confirm the owner of a ticket and enables a ticket purchaser to prove ownership even if their electronic ticket is not available on their mobile phone or other electronic device at the time the ticket owner seeks admission to the event, as the ticket or invitation is being tracked from the point of origin to the final usage of the ticket or invitation.

This invention enable event producers to effortlessly re-issue tickets or credits to ticket holders in the event of an event cancellation, even though the final ticket holder maybe different than the first or original ticket holder or purchaser.

A further aspect of this invention is the establishment of a forum for fans to communicate with one another through the ticket social media functions, during an event and beyond.

This invention enables event producers to provide monetary and non-monetary rewards, loyalty points, and other benefits to ticket purchaser including event highlights encompassing audio, music and other digital streaming, as each ticket holder is clearly identified, and tracked via their ticket or invitation.

This invention enables event attendees to publicly identify themselves and their location to other attendees, including the ability to control their public identification to all attendees or subcategory of attendees, such as, those in the same section, or fan base, or belonging to a group, or a corporate sponsor, to name a few.

This invention enables and/or provides an option to event attendees to create private, or public chats, in their electronic ticket with other attendees, and/or invite one or more group of event attendees for a limited interaction.

TICKETSAFE-A software and process for electronic tickets that:

The invention identifies all application users at an event and enables event producers to communicate with all ticket holders instantaneously during the event to provide updates on the event, including digital streaming of audio, music, video, any updates, promotions, trivia challenges, to name a few.

This invention enables event producer sponsor to provide public announcements via their ticket into ticket holder's mobile phones or any handheld electronic device.

This invention enables in the in case of emergencies emergency response and other public responders to provide emergency directions to attendees, including communicating escape routes if required. When coupled with mobile phone based location based services, can enable instructions tailored to specific locations within a theater, arena, stadium, or venue.

The invention can use any of the existing applications or software for block chain standards to ticketing, or it could use any of the comparable or compatible ticket issuing application or software, or could use a customized ticket issuing application or software. For the purposes of explaining the invention the invention will focus on the layer above the blockchain where the unique aspects of this invention reside or are used. Additionally, for the purposes of illustration the application will initially focus on three primary or main categories or features of the present invention.

FIG. 1, illustrates a flow diagram for a first embodiment of the invention. The first embodiment of the invention illustrates an integrated market 21, between at least one primary market 10, and at least one secondary market 20. The primary market 10, has at least one vendor having a set of tickets 1, 2, 3, . . . , x, y, z, . . . , n, for sale 12. A first buyer A, purchases a ticket y, at step 14, and then the first buyer A, puts the ticket y, for resale at step 16, in the resale market 18. The vendor 30, in the primary market 10, also puts any of the unsold tickets 12, at step 13, to be sold in the secondary market 20. The invention now integrates all the tickets 12, which are unsold from step 13, and the tickets 12, that are for resale in the resale market 18, onto one integrated platform 15. So, now, when a second buyer 13, is interested in purchasing at least one ticket 12, the second buyer B, can directly go to the primary market 10, via step 17, and see what tickets 12, are available, and that is when the second buyer B, will see that ticket y, is not available on the primary market 10, and thus will have to make a purchase from the primary market 10, of one or more of the tickets 12, that might still be available. However, the second buyer B, now also has the option of going onto the inventive integrated platform 15, at step 19, and there the second buyer B, will readily see all the tickets 12, that are available for purchase, namely, the unsold tickets 12, and the resale tickets 12, including the ticket y, albeit via the resale market 18, and maybe for a different price, or a different terms and conditions. Thus, the second buyer B, now has an option using the inventive application to make a decision which was not available via step 17. Thus, the ticket vendor 30, in the primary market 10, provides a single combined presentation of the two sides of the market so that a second buyer B, could buy, for instance, one ticket in the primary market 10, and another ticket in the secondary market 20, and that has an additional benefit that the second buyer B, gets two seats together, or adjacent, or in the same row, or in the same section, or at the same venue, and combinations thereof, to name a few. The invention allows a second buyer B, to be able to see both the unsold tickets 12, and the resale market 18, tickets 12, simultaneously, in one integrated seating chart or platform 15, and then can buy seats or tickets 12, in an integrated fashion, from a single location 15.

FIG. 2, illustrates a flow diagram for a second embodiment of the invention. The second embodiment of the invention illustrates a live ticket 33, feature of the inventive ticket 12. A seller 30, could partner with a promotor 35, or an event producer 35, or a third party 35, and combinations thereof, and could convert the electronic ticket 12, into a multimedia ticket 32, by adding additional features, such as, for example, an entrance pass 31, an audio message 34, a video clip or stream 36, a text or message 37, a promotion 38, and combinations thereof, to name a few, which could be displayed or available via a platform 39, a webpage 39, a screen 39, a mini-web page 39, and combinations thereof, to name a few, for the buyer B, of the ticket at step 17, 19. The live ticket 33, allows one to have additional information on a ticket 12, which is more than an entrance pass 31, and can include audio 34, video 36, text 37, and other materials, that the seller 30, and/or the event producer 35, wants to attach, and stream onto the ticket 12. This ticket 12 in effect becomes a mini-web page 39, for the buyer B.

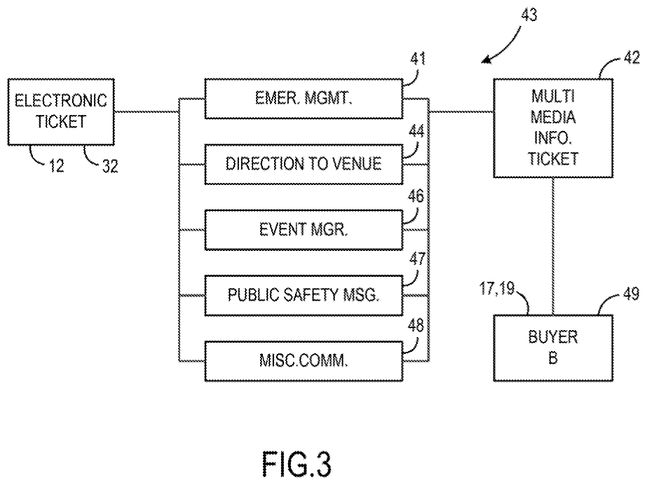

FIG. 3, illustrates a flow diagram for a third embodiment of the invention. The third embodiment of the invention illustrates a Ticketsafe 43, feature of the invention. The ticket 12, 32, could also be provided with additional information by the seller 30, or a promotor 35, or an event producer 35, or a third party 35, such as, for example, emergency management 41, directions to the venue 44, contact between the event manager 46, public safety official message(s) 47, miscellaneous communication 48, and combinations thereof, to name a few, to make the ticket 12, 32, into an informational multimedia ticket 42, for the buyer B 49, or a ticketholder 49. The Ticketsafe 43, feature of this invention provides emergency management 41, directions 44, contact between the event manager 46, public safety officials 47, and a ticketholder 49.

It should be understood that features of the invention illustrated with reference to the first embodiment, can be integrated with the features illustrated with reference to the second embodiment, and/or the features illustrated with reference to the third embodiment, and combinations thereof.

The innovative features used in the present invention, may be implemented using one or more computers executing software instructions. According to one embodiment of the present invention, the inventive application may communicate with at least one server, at least one client computer system which transmits and receives data over a computer network or a fiber or copper-based telecommunications network or a wireless network. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of a server or a client computer from a storage device or from one or more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the CPU may directly support the downloaded instructions. In other cases, the instructions may not be directly executable by the CPU, and may instead be executed by an interpreter that interprets the instructions. In other embodiments, hardwired circuitry may be used in place of, or in combination with, software instructions to implement the present invention. Thus tools used in the present invention are not limited to any specific combination of hardware circuitry and software, nor to any particular source for the instructions executed by the server or client computers. In some instances, the client and server functionality may be implemented on a single computer platform.

Thus, the present invention is not limited to the embodiments described herein and the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

Still further, while certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions.

It should be further understood that throughout the specification and claims several terms have been used and they take the meanings explicitly associated herein, unless the context clearly dictates otherwise. For example, the phrase “in one embodiment” as used herein does not necessarily refer to the same embodiment, though it may. Additionally, the phrase “in another embodiment” as used herein does not necessarily refer to a different embodiment, although it may. Thus, various embodiments of the invention may be readily combined, without departing from the scope or spirit of the invention.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as filling within the true scope and spirit of the present invention.

What is claimed is:

1. A method of providing electronic tickets to a buyer, comprising the steps of:
(a) At least one vendor selling at least two tickets in at least one primary market;
(b) At least one first buyer buying at least one first ticket from said at least one vendor, and wherein said at least one first buyer places said at least one first ticket on at least one resale website;
(c) Said at least one vendor placing unsold tickets on at least one second website;
(d) At least one platform integrating said at least one first ticket from said at least one resale website, and said unsold tickets from said at least one second website on said at least one platform; and
(e) At least one second buyer buying said at least one first ticket on said at least one platform, and at least one unsold ticket on said at least one platform.

2. The method of claim 1, wherein said at least one first ticket, and said at least one unsold ticket, are selected from a group consisting of, adjacent each other, in the same row, in the same section, at the same venue, and combinations thereof.

3. The method of claim 1, wherein said at least one first ticket has a first price, and said at least one unsold ticket has a second price.

4. The method of claim 1, wherein said at least one first ticket has a first price, and said at least one unsold ticket has a second price, and wherein said first price is different than said second price.

5. A method of providing electronic tickets to a buyer, comprising the steps of:
(a) At least one seller selling at least one ticket in at least one primary market;
(b) At least one entity converting said at least one ticket into a multimedia ticket by providing at least one enhancement to said ticket; and
(c) Wherein said at least one enhancement is visible on at least one platform which can be viewed by at least one buyer.

6. The method of claim 5, wherein said at least one entity converting said at least one ticket into said multimedia ticket is selected from a group consisting of a seller, a promotor, an event producer, a third party, and combinations thereof.

7. The method of claim 5, wherein said at least one enhancement to said ticket is selected from a group consisting of an entrance pass, an audio message, a video clip, a video stream, a text message, a promotion, and combinations thereof.

8. The method of claim 5, wherein said at least one enhancement to said ticket is displayed on a platform, a webpage, a screen, a mini-web page, and combinations thereof.

9. A method of providing electronic tickets to a buyer, comprising the steps of:
(a) At least one seller selling at least one ticket in at least one primary market;
(b) At least one entity converting said at least one ticket into an informational multimedia ticket by providing at least one informational enhancement to said ticket; and
(c) Wherein said at least one informational enhancement is visible on at least one platform which can be viewed by at least one buyer.

10. The method of claim 9, wherein said at least one entity converting said at least one ticket into said multimedia ticket is selected from a group consisting of a seller, a promotor, an event producer, a third party, and combinations thereof.

11. The method of claim 9, wherein said at least one informational enhancement to said ticket is selected from a group consisting of an emergency management, directions to the venue, contact between the event manager, public safety official message, miscellaneous communication, and combinations thereof.

2. The method of claim 9, wherein said at least one informational enhancement to said ticket is displayed on a platform, a webpage, a screen, and combinations thereof.
